(19) United States
(12) Patent Application Publication
(10) Pub. No.: US 2011/0240884 A1
(43) Pub. Date: Oct. 6, 2011

(54) OPTICAL TOMOGRAPHIC MEASURING DEVICE

(75) Inventor: Hiroaki YAMAMOTO, Ashigarakami-gun (JP)

(73) Assignee: FUJIFILM Corporation, Tokyo (JP)

(21) Appl. No.: 12/979,209

(22) Filed: Dec. 27, 2010

(30) Foreign Application Priority Data
Mar. 31, 2010 (JP) 2010-082238

(51) Int. Cl. G01J 1/58

(52) U.S. Cl. 250/458.1; 250/200

(57) ABSTRACT

An optical tomographic measuring device that includes: an illuminating component, a plurality of light-receiving components, a storage component, a specifying component, an acquiring component, and a constructing component is provided. The specifying component specifies a position of the measurement plane in the body length direction. The acquiring component acquires, from the storage component, an optical characteristic distribution that corresponds to the position specified by the specifying component. The constructing component constructs a density distribution of fluorescence in the measurement plane, on the basis of intensities of the fluorescence received at the respective light-receiving components and the optical characteristic distribution acquired by the acquiring component.

### CROSS-REFERENCE TO RELATED APPLICATION

This application claims priority under 35 USC 119 from Japanese Patent Application No. 2010-082238 filed on Mar. 31, 2010, the disclosure of which is incorporated by reference herein.

### BACKGROUND OF THE INVENTION

1. Field of the Invention

The present invention relates to an optical tomographic measuring device that measures fluorescence, that is emitted from a living body that is an object of measurement in accordance with excitation light, and reconstructs an optical tomographic image.

2. Description of the Related Art

It is known that tissue of a living body is light-transmissive with respect to light of predetermined wavelengths, such as near infrared rays and the like. From this, observation of the interior of a living body by using light (optical tomography: optical CT) is proposed in Japanese Patent Application Laid-Open (JP-A) Nos. 11-173976, 11-337476, and the like.

Optical CT is a technique that obtains the distribution of the absorption coefficient of light within a living body, and determines the absorption coefficient distribution at the interior of a scattering/absorbing body that is an object of measurement from detected light amounts, that are obtained by using a phantom model, and detected light amounts, that are obtained from the object of measurement.

JP-A Nos. 10-026585, 11-311569 and the like propose, by combining plural light incidence positions and light detection positions that are in the same relative positional relationship with respect to one point of an object of measurement, using, as a reference value for determining an internal characteristic distribution such as the absorption coefficient distribution or the equivalent scattering coefficient distribution or the like, an average value of plural measured values that are detected at the light detection positions due to light being incident from the respective light incidence positions and passing through the object of measurement. Due thereto, reconstruction of the absorption coefficient distribution is carried out without using an object of measurement that is based on a phantom model or the like.

Further, as a tomographic image measuring device that utilizes the light transmitting property of tissue of a living body, there is proposed a fluorescence tomographic image measuring device that illuminates excitation laser light with respect to a sample, and takes-in, of the fluorescence that is emitted due to the excitation light being scattered at a source of fluorescence within an object of measurement, the O-order light of the Fraunhofer diffraction image of a plane wave that is obtained by removing the scattered light, thereby obtaining an optical tomographic image (see, for example, JP-A No. 05-223738).

On the other hand, a fluorescent labeling agent, that provides a fluorescent substance to antibodies that adhere uniquely to a lesion such as a tumor or the like, is used, and, by administering the fluorescent labeling agent to a living body, the movement of the fluorescent labeling agent within the living body and the accumulating/dispersing process thereof at a specific region can be observed from the density distribution of the fluorescence that is emitted from the living body (fluorescence CT).

In a case of obtaining the density distribution of a fluorescent labeling agent within a living body (hereinafter called the density distribution of fluorescence), excitation light is illuminated toward one point of the surface of the living body, and the intensity of the fluorescence that exits from the living body due thereto is detected at multiple points at the periphery of the living body. Relationships corresponding to the distribution of the fluorescent labeling agent, the scattering characteristic of the light within the living body, and the absorption characteristic of the light within the living body are established among the measurement data that are obtained by repeatedly carrying this process out while changing the illumination position of the excitation light. By using these relationships, reconstruction of a tomographic image that expresses the density distribution of the fluorescence can be carried out from the measurement data.

In fluorescence CT, in a case of carrying out reconstruction of a tomographic image, the intensity distribution of the excitation light and the intensity distribution of the fluorescence can be obtained by inverse problem computation that is based on a diffusion equation of light. In this inverse problem computation, the absorption coefficient μa of light and scattering coefficient (equivalent scattering coefficient μs′) within the living body are unknown, computation of the absorption coefficient pa and equivalent scattering coefficient μs′ is carried out, and the density distribution of the fluorescence is obtained on the basis of these computational results.

When obtaining the density distribution of the fluorescence, the intensity of the excitation light and the intensity of the fluorescence are each measured at multiple places. Carrying out inverse problem computation in two systems by using the respective measurement results requires time for the measuring work, and the computation time also is long.

### SUMMARY OF THE INVENTION

The present invention was made in view of the above-described circumstances, and an object thereof is to provide an optical tomographic measuring device that, when carrying out reconstruction of a tomographic image that expresses the density distribution of fluorescence within a living body that is an object of measurement, can reconstruct an accurate optical tomographic image by a simple structure.

In order to achieve the above-described object, the present invention has: an illuminating component whose optical axis is disposed so as to be in a measurement plane that intersects a body length direction of a living body that is an object of measurement and to which a fluorescent labeling agent is administered, the illuminating component illuminating excitation light toward the object of measurement; plural light-receiving components whose respective optical axes are disposed so as to be in the measurement plane, the light-receiving components receiving fluorescence, that is emitted from the fluorescent labeling agent due to the excitation light illuminated from the illuminating component and that exits at a periphery of the object of measurement; a storage component that stores an optical characteristic distribution of the object of measurement; a specifying component that specifies a position of the measurement plane in the body length direction; an acquiring component that acquires, from the storage component, an optical characteristic distribution that corresponds to the position specified by the specifying component; and a constructing component that constructs a density distribution of fluorescence in the measurement plane, on the basis of intensities of the fluorescence received at the respective light-receiving components and the optical characteristic distribution acquired by the acquiring component.

In accordance with this invention, the specifying component specifies the position of the measurement plane in the body length direction. In accordance with the specified position, the optical characteristic distribution of the object of measurement is acquired. The density distribution of the fluorescence in the measurement plane is constructed on the basis of the intensities of the received fluorescence and the acquired optical characteristic distribution.

Due thereto, the present invention is used in acquiring and reconstructing an optical characteristic distribution in the measurement plane that corresponds to the position of the object of measurement in the body length direction. Therefore, an accurate optical tomographic image can be reconstructed by a simple structure.

Further, the present invention also has a moving component that moves the measurement plane by moving the illuminating component and the light-receiving components as a set, relative to the object of measurement along the body length direction, wherein the specifying component specifies the position of the measurement plane on the basis of a movement amount of the moving component.

In accordance with this invention, due to the moving component moving the illuminating component and the light-receiving components, as a set, relatively along the body length direction, the measurement plane is moved. The specifying component specifies the position of the measurement plane on the basis of the movement amount of the moving component.

Due thereto, in the present invention, because the position of the measurement plane can be specified on the basis of the movement amount of the moving component, the position of the measurement plane can be grasped accurately from the movement amount, and an optical characteristic distribution corresponding to the measurement position can be acquired.

Further, in the present invention, the optical characteristic distribution is set in advance in accordance with at least one of lungs, a heart, a stomach, a liver, intestines, kidneys, bones, muscles and fat that structure the living body.

Moreover, in the present invention, the optical characteristic distribution is structured by an absorption coefficient and an equivalent scattering coefficient of light.

As described above, in accordance with the present invention, there is the effect that, when reconstructing a tomographic image expressing the density distribution of fluorescence within a living body that is an object of measurement, an accurate optical tomographic image can be reconstructed by a simple structure.

### BRIEF DESCRIPTION OF THE DRAWINGS

FIG. 1 is a schematic structural drawing of main portions of an optical tomographic measuring system relating to an exemplary embodiment;

FIG. 2 is a schematic perspective view showing an example of a subject holder that is used in holding a mouse;

FIG. 3 is a perspective view showing main portions of an optical measuring device;

FIG. 4 is a schematic structural drawing showing measurement positions of fluorescence;

FIG. 5 is a schematic structural drawing of a control section of the optical tomographic measuring system;

FIG. 6A is a schematic drawing showing the arrangement of internal structures within a mouse that is held in the subject holder;

FIG. 6B is a schematic drawing showing a cross-section of the chest portion of the mouse;

FIG. 6C is a schematic drawing showing a cross-section of the abdominal portion of the mouse;

FIG. 6D is a schematic drawing showing a cross-section of the hip portion of the mouse;

FIG. 7 is a flowchart showing an overview of measuring processing in the optical measuring device;

FIG. 8 is a flowchart showing an overview of density distribution computation using measurement data;

FIG. 9 is a schematic drawing showing an example of the cross-sectional distribution of the chest portion of the mouse that is used in confirming the principles of the present invention;

FIG. 10 is a schematic drawing of a reconstructed image of fluorescence in a case using the optical tomographic measuring system relating to the present exemplary embodiment; and

FIG. 11 is a schematic drawing of a reconstructed image of fluorescence in a case in which the mouse overall is set to the same optical characteristic value in accordance with a conventional method.

### DETAILED DESCRIPTION OF THE INVENTION

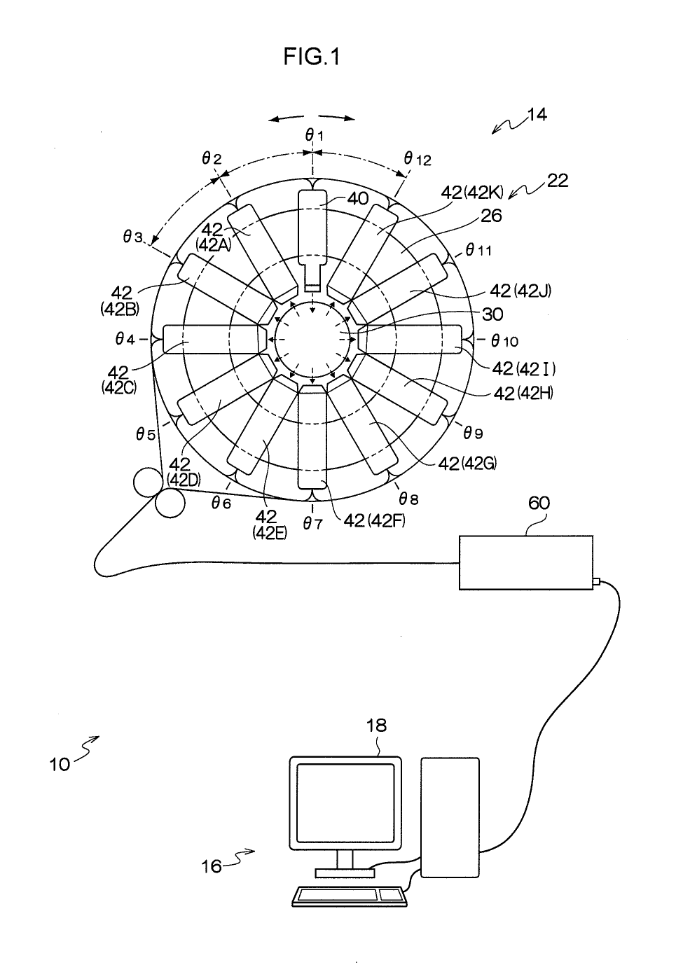

An exemplary embodiment of the present invention is described hereinafter with reference to the drawings. The schematic structure of an optical tomographic measuring system 10 relating to the present exemplary embodiment is shown in FIG. 1. The optical tomographic measuring system 10 has an optical measuring device 14 and a data processing device 16 that carries out predetermined data processing on measurement data that is obtained at the optical measuring device 14. Note that the optical tomographic measuring, system 10 may be a structure in which the functions of the optical measuring device 14 and the functions of the data processing device 16 are integrated.

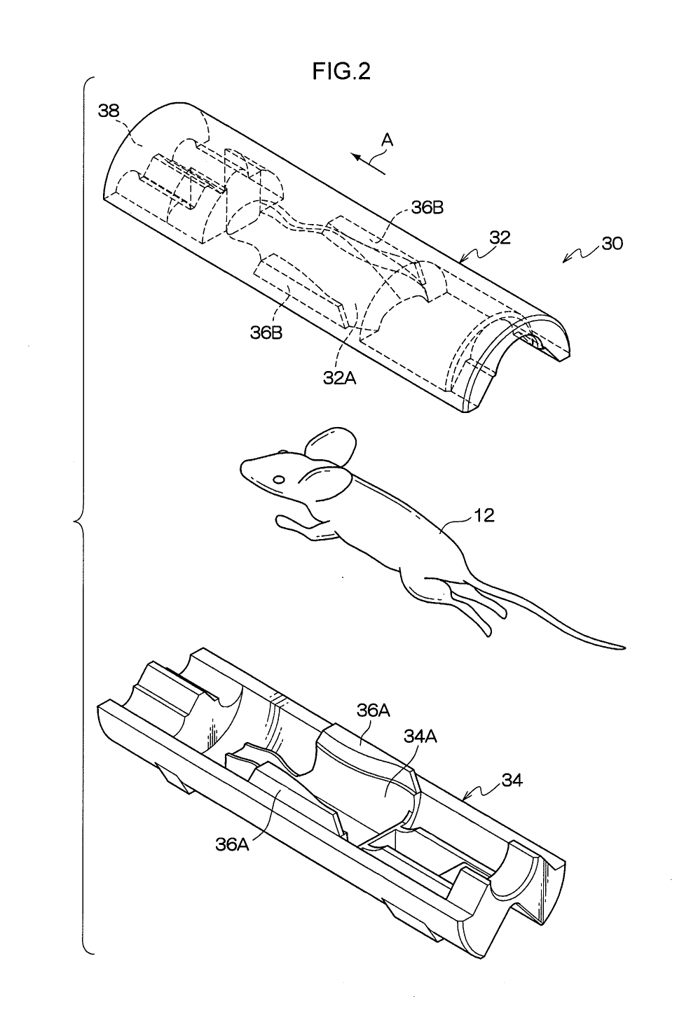

At the optical tomographic measuring system 10, a living body, such as a nude mouse or the like for example, is the object of measurement. Description is given hereinafter with the object of measurement being a mouse 12 (see FIG. 2). Note that the object of measurement is not limited to the mouse 12, and an arbitrary living body can be used as the object of measurement.

Lesion cells, such as tumor cells or the like for example, are injected or the like into the mouse 12 that is the object of measurement, so as to give rise to (manifest) a predetermined lesion. Further, a fluorescent labeling agent, that causes a fluorescent substance to be contained in antibodies that adhere uniquely to a specific region such as the lesion or the like for example, is administered to the mouse 12.

At the optical tomographic measuring system 10, the mouse 12 is loaded into the optical measuring device 14 at the time when, after the fluorescent labeling agent administered to the mouse 12 in which the lesion was generated disperses within the body of the mouse 12 due to blood circulation, the fluorescent labeling agent accumulates at and adheres to the lesion due to the antigen-antibody reaction. The optical measuring device 14 illuminates, toward the mouse 12, excitation light with respect to the fluorescent labeling agent, and measures the fluorescence intensity emitted from the fluorescent labeling agent within the body of the mouse 12. At the data processing device 16, the density distribution of the fluorescence (the fluorescent labeling agent) within the mouse 12 is computed on the basis of the measurement data that corresponds to the fluorescence intensity outputted from the optical measuring device 14, and a tomographic image, that shows the density distribution of the fluorescent labeling agent (the fluorescent substance) within the body, is generated (an optical tomographic image is reconstructed). The reconstructed optical tomographic image is, for example, displayed on a monitor 18 or the like.

As shown in FIG. 2, in the optical tomographic measuring system 10, when the mouse 12 is loaded in the optical measuring device 14, the mouse 12 is accommodated and held in a subject holder 30. The subject holder 30 is structured by an upper mold block 32 and a lower mold block 34, and becomes a substantially cylindrical shape of a predetermined outer diameter due to the upper mold block 32 and the lower mold block 34 being superposed one on the other.

A recess 32A, that conforms to the physique (the outer shape and size) of the dorsal side of the mouse 12, is formed in the upper mold block 32. A recess 34A, that conforms to the physique of the ventral side of the mouse 12, is formed in the lower mold block 34. Due to the upper mold block 32 being placed on the lower mold block 34 in the state in which the ventral side of the mouse 12 is accommodated within the recess 34A of the lower mold block 34, the mouse 12 is disposed such that the body length direction thereof runs along the axial direction of the subject holder 30, and is held in the subject holder 30 with the skin thereof closely contacting the inner surface of the subject holder 30.

In the present exemplary embodiment, mainly the torso portion (from the chest portion to the hip portion) of the mouse 12 is the measurement region, and the subject holder 30 holds the mouse 12 in a state in which the skin of at least the torso portion of the mouse 12 closely contacts the inner surface of the subject holder 30. Further, at the subject holder 30, the position of the mouse 12 within the subject holder 30 can be prescribed by the position at which the recess 32A is formed in the upper mold block 32 and the position at which the recess 34A is formed in the lower mold block 34.

At the subject holder 30, for example, the end surface at the head portion side of the mouse 12 is a reference surface 38. Due thereto, when the mouse 12 is accommodated in the subject holder 30, the position of the measurement region is prescribed in accordance with the physique (size). Note that, at the subject holder 30, positioning between the upper mold block 32 and the lower mold block 34 is carried out by, for example, a pair of engaging projections 36A that are formed at the lower mold block 34 being fit into engaging recesses 36B that are formed in the upper mold block 32. Further, an arbitrary shape such as a prism or the like can be used for the subject holder 30 provided that it is an external shape that is stipulated in advance.

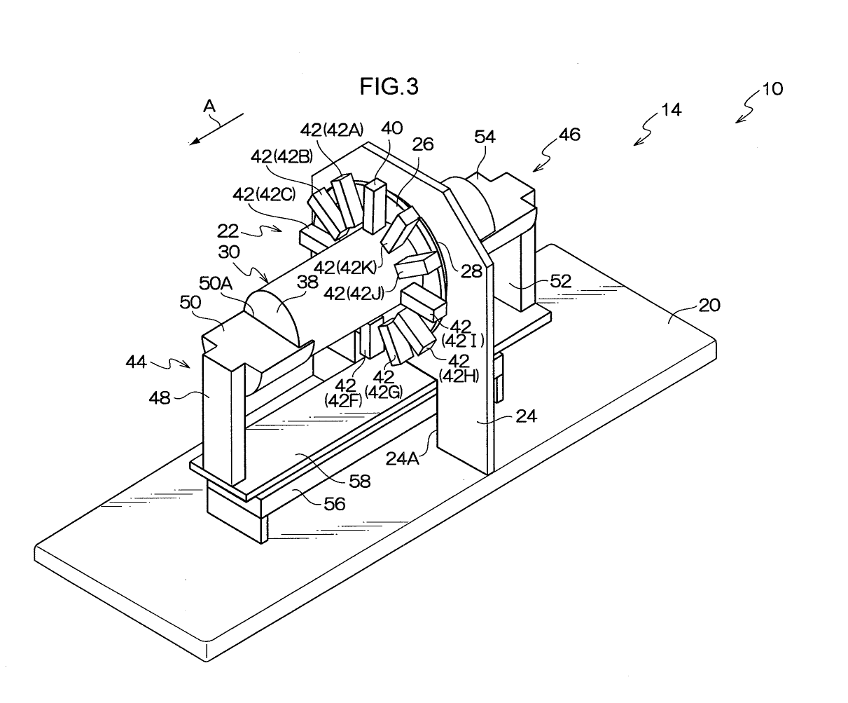

As shown in FIG. 3, a stand 20 is disposed at the interior of the optical measuring device 14, which interior is shielded from light by an unillustrated casing. A base plate 24 stands erect on this stand 20. A measuring head portion 22 is provided at one surface of the base plate 24. The measuring head portion 22 has a frame 26 that is formed in the shape of a ring for example, and the frame 26 is disposed so as to be coaxial with an unillustrated circular hole that is formed in the base plate 24.

A rotary actuator 28 is mounted to one surface of the base plate 24. The frame 26 is mounted to the rotary actuator 28. An unillustrated cavity portion, that corresponds to the circular hole of the base plate 24, is formed in the rotary actuator 28, and the cavity portion is mounted to the base plate 24 so as to be coaxial with the circular hole. The frame 26 is mounted so as to be coaxial with the cavity portion of the rotary actuator 28.

Due to an unillustrated drive source that uses, for example, a stepping motor, a pulse motor or the like, being operated, the rotary actuator 28 rotates the frame 26 around the axially central portion thereof with respect to the base plate 24.

Arms 44, 46 are provided at the optical measuring device 14 as a pair with the base plate 24 sandwiched therebetween. At the arm 44, a bracket 50 is mounted to the distal end portion of a support 48, and the distal end of the bracket 50 passes through the opening of the frame 26 and is directed toward the arm 46 side. Further, at the arm 46, a bracket 54 is mounted to the distal end portion of a support 52, and the distal end of the bracket 54 passes through the opening of the frame 26 and is directed toward the arm 44 side.

An elongated slider 56 and slide base 58 are disposed above the stand 20. The longitudinal direction of the slider 56 is disposed along the axial direction of the frame 26. The slider 56 is inserted through an opening portion 24A that is formed in the lower end portion of the base plate 24, and is mounted on the base 20. The slide base 58 is disposed on the slider 56 such that the longitudinal direction of the slide base 58 runs along the longitudinal direction of the slider 56. The slide base 58 is mounted to the slider 56 via an unillustrated block that is provided at the slider 56. The support 48 of the arm 44 stands erect at one longitudinal direction end side of the slide base 58, and the support 52 of the arm 46 stands erect at the other end side.

A feed screw mechanism is provided at the interior of the slider 56. Due to the feed screw being driven and rotated, an unillustrated block that is connected to the feed screw is moved. The slider base 58 is mounted to the block that is connected to the feed screw, and is moved along the longitudinal direction (the left-right direction of the drawing of FIG. 3) by the feed screw mechanism. Due thereto, at the optical measuring device 14, the pair of arms 44, 46 are moved integrally in the axial direction of the frame 26.

Note that a general, known structure can be used as the feed screw mechanism, and detailed description thereof is omitted here. Further, the structure of moving the pair of arms 44, 46 integrally is not limited to a feed screw mechanism, and an arbitrary, known structure can be used. Moreover, in the present exemplary embodiment, the arms 44, 46 move, but the present invention is not limited to the same and may be a structure in which the frame 26 (the measuring head portion 22) moves.

At the optical measuring device 14, the subject holder 30 is installed so as to span between the bracket 50 of the arm 44 and the bracket 54 of the arm 46. At this time, the subject holder 30 is disposed such that the axis thereof overlaps the axis of the frame 26. Further, the mouse 12 within the subject holder 30 is positioned along the body length direction with respect to the optical measuring device 14 due to the reference surface 38 of the subject holder 30 being abutted against a reference surface 50A that is set at the bracket 50.

At the optical measuring device 14, a state in which the bracket 50 of the arm 44 is inserted-through an unillustrated through-hole of the base plate 24 and projects-out toward the opposite side of the base plate 24 (the far back side in the drawing of FIG. 3) is the position at which the subject holder 30 is installed at and removed from the brackets 44, 46. At the optical measuring device 14, when the subject holder 30 is installed at this installation/removal position, by driving the slider 56, the subject holder 30 moves (in the direction of arrow A) so as to pass through the axially central portion of the frame 26. Further, at the optical measuring device 14, removal of the subject holder 30 from the arms 44, 46 is carried out by the subject holder 30 being moved in the direction opposite to the direction of arrow A and returned to the installation/removal position.

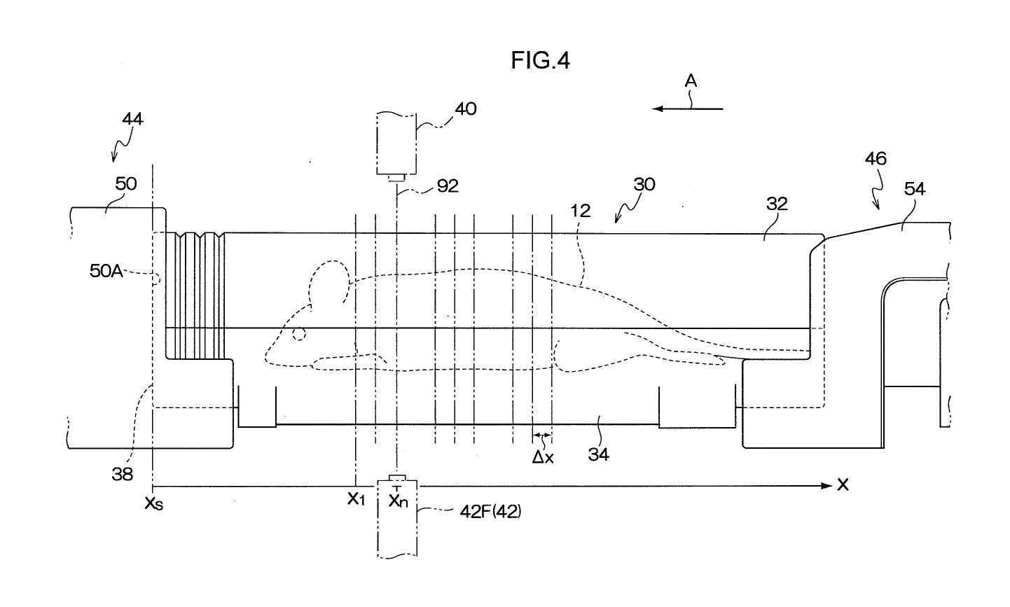

On the other hand, as shown in FIG. 1, a light source unit 40 and plural light-receiving units 42 are mounted to the measuring head portion 22. The respective optical axes of the light source unit 40 and the light-receiving units 42 are directed toward the axial center of the frame 26 and are in the same plane (see FIG. 4, hereinafter called “measurement plane 92”) that intersects the axial direction of the frame 26. Further, as shown in FIG. 1, the light source unit 40 and the light-receiving units 42 are disposed in a radial form from the axial center of the frame 26, such that the angles between the optical axes thereof are a predetermined angle θ. Note that, in the present exemplary embodiment, as an example, the one light source unit 40 and eleven light-receiving units 42A, 42B, 42C, 42D, 42E, 42F, 42G, 42H, 42I, 42J, 42K are provided, and are disposed such that the angle θ is 30°.

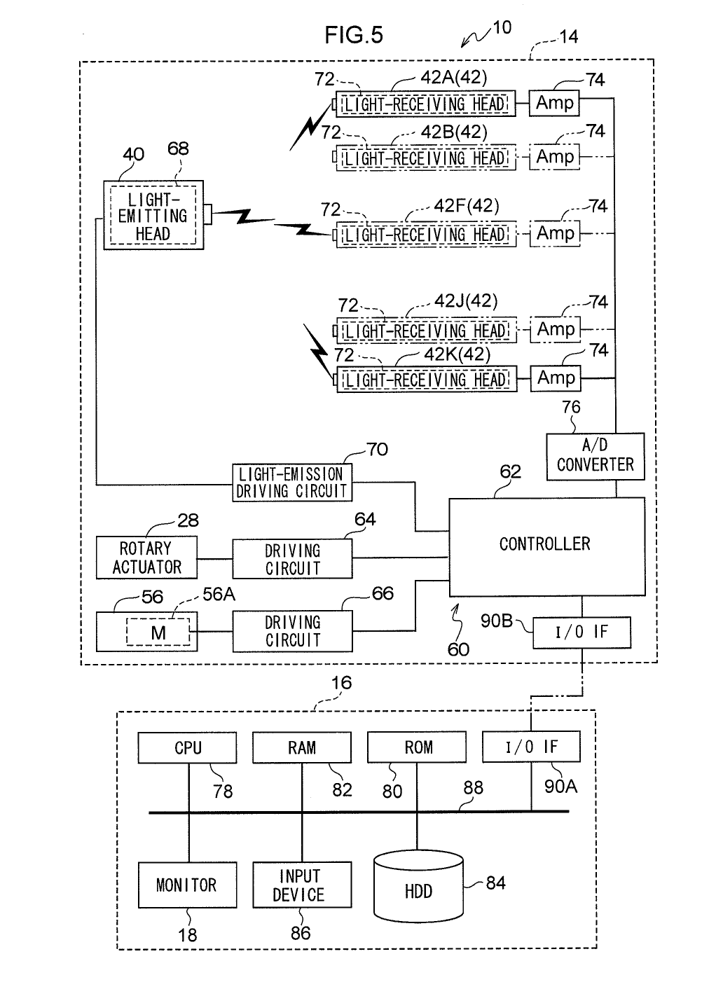

On the other hand, as shown in FIG. 5, a control section 60 is provided at the optical measuring device 14. The control section 60 has a controller 62 that is equipped with an unillustrated microcomputer. A driving circuit 64 that drives the rotary actuator 28, and a driving circuit 66 that drives the slider 56, are provided at the control section 60, and are connected to the controller 62. The movement of the subject holder 30 and the rotation of the measuring head portion 22 are controlled by the controller 62 at the optical measuring device 14.

Further, the light source unit 40 has a light-emitting head 68 that, by a light-emitting element such as a semiconductor laser or the like, emits light of a predetermined wavelength that is the excitation light with respect to the fluorescent labeling agent. Each of the light-receiving units 42 has a light-receiving head 72 that, by a light-receiving element, receives fluorescence emitted by the fluorescent labeling agent. The control section 60 has a light emission driving circuit 70 that drives the light-emitting head 68 provided at the light source unit 40, amplifiers (amp) 74 that amplify electric signals outputted from the light-receiving heads 72 provided at the respective light-receiving units 42, and an A/D converter 76 that carries out A/D conversion on the electric signals (analog signals) outputted from the amplifiers 74.

Due thereto, at the control section 60, the measurement data, that is detected by the light-receiving heads 72 of the respective light-receiving units 42, is outputted as digital signals while the emission of light by the light-emitting head 68 of the light source unit 40 is controlled. Note that an unillustrated display panel is provided at the optical measuring device 14, and the operating state of the device and the like are displayed by the controller 62.

A computer of a general structure in which a CPU 78, a ROM 80, a RAM 82, an HDD 84 that is a storage component, an input device 86 such as a keyboard or a mouse (a pointing device) or the like, the monitor 18, and the like are connected to a bus 88, is formed at the data processing device 16. An input/output interface (I/O IF) 90A is provided at the data processing device 16. The input/output interface 90A is connected to an input/output interface 90B that is provided at the control section 60 of the optical measuring device 14. Note that a known, arbitrary standard, such as a USB interface or the like, can be applied to the connection between the optical measuring device 14 and the data processing device 16.

The data processing device 16 controls the operations of the optical measuring device 14 due to the CPU 78 executing programs stored in the ROM 80 or the HDD 84 by using the RAM 82 as a work memory.

Due thereto, at the optical measuring device 14, in a state in which the subject holder 30 installed at the arms 44, 46 is moved in the axial direction and a predetermined position of the subject holder 30 (a predetermined region of the mouse 12) is disposed at the axially central portion (the measurement plane 92) of the frame 26, excitation light is illuminated from the light source unit 40 toward the subject holder 30. The fluorescence, that is emitted from the fluorescent labeling agent within the mouse 12 in accordance with this excitation light and exits from the periphery of the subject holder 30, is received at the respective light-receiving units 42. Data corresponding to the received light amounts is outputted as measurement data to the data processing device 16.

The data processing device 16 carries out reconstruction of the density distribution of the fluorescence on the basis of the measurement data outputted from the optical measuring device 14. Note that description is given of a case in which, in the optical tomographic measuring system 10, the data processing device 16 controls the operations of the optical measuring device 14. However, the present invention is not limited to the same, and may be a structure in which the optical measuring device 14 operates independently, and outputs the measurement data.

As shown in FIG. 4, in the optical tomographic measuring system 10, the subject holder 30 is installed in the optical measuring device 14 with the reference surface 38 of the subject holder 30 being made to abut the reference surface 50A of the bracket 50. Due thereto, at the optical measuring device 14, the reference surface 50A of the bracket 50 is origin xs, and the subject holder 30 is relatively moved in the direction of arrow X such that a predetermined position of the subject holder 30 faces the measuring head portion 22. Note that, in the following explanation, description is given with the body length direction of the mouse 12 within the subject holder 30 (the axial direction of the frame 26) being the x-axis, and the coordinate, on the x-axis, of the position of relative movement of the measurement plane 92 from the origin xs with respect to the subject holder 30 being measurement position x.

In the optical measuring device 14, a position that is set in advance is an initial position for measurement (measurement position x₁), and measurement of fluorescence is carried out at each measurement position xn to which the subject holder 30 is moved relatively, at a predetermined interval Δx (e.g., Δx=3 mm) each time from the measurement position x₁. At this time, in the optical measuring device 14, at each of the measurement positions xn, the light source unit 40 is rotated from a preset original position by a predetermined angle θ each time (e.g., from an original position θ₁ to rotational positions θ₂, θ₃, . . . θ₁₂ (see FIG. 1)). At each rotational position θₚ (here, p=1 through 12), excitation light is illuminated from the light source unit 40 toward the subject holder 30, and measurement data M(m), that are output signals of the light-receiving units 42A through 42K, are read-in. Note that m=1 through 11, and m is a variable that specifies the light-receiving unit 42A through 42K.

Due thereto, in the optical measuring device 14, measurement data M(xn, θp, m) is obtained as measurement data M(x, θ, m). At this time, if the measurement position x is the same, the measurement data M(x, θ, m) are data in the same plane (the measurement plane 92) that intersects the moving direction of the subject holder 30.

On the other hand, the living body such as the mouse 12 or the like is an anisotropic scattering medium with respect to light. At an anisotropic scattering medium, until the incident light reaches the light penetration length (equivalent scattering length), there is a region at which forward scattering is dominant, and, in regions past the light penetration length, multiple scattering (isotropic scattering) in which the deflection of the light is random occurs, and the scattering of the light becomes isotropic (isotropic scattering region). The region in which the forward scattering is dominant is around several mm. Therefore, at the region at a depth of around several mm or more from the surface of an anisotropic scattering medium, there can be considered to be isotropic scattering.

In the present exemplary embodiment, the mouse is accommodated in the subject holder 30 (the upper mold block 32 and the lower mold block 34) that has a thickness of greater than or equal to the light penetration length, so that the scattering of light within the body of the mouse 12 is considered to substantially be an isotropic scattering region. Polyethylene (PE), or polyacetal resin (POM) whose equivalent scattering coefficient μs′ of light is 1.05 mm⁻¹, or the like can be used as the material of the subject holder 30. Note that the material that forms the subject holder 30 is not limited to these, and an arbitrary material, that is such that the interior of the body of the mouse 12 is considered to be an isotropic scattering region, can be used.

When light propagates within a highly-dense medium while being scattered, the distribution of the light intensity is expressed by a transport equation of light (photons) that is a basic equation describing the flow of energy of photons. However, due to the scattering of the light approximating isotropic scattering, the distribution of the light intensity can be expressed by using a light diffusion equation.

This light diffusion equation is expressed by formula (1). Note that Φ(r,t) represents the light density within the mouse 12, D(r) represents the diffusion coefficient, μa(r) represents the absorption coefficient, q(r,t) represents the light density of the light source, r represents the coordinate position within the mouse 12 that is the object of measurement (i.e., within the subject holder 30), and t represents time.

$$\{ \frac{1}{c} \frac{\partial φ}{\partial t} - ∇ \cdot D ( r ) ∇ + {μ}_{a} ( r ) \} Φ ( r , t ) = - q ( r , t ) \qquad ( 1 )$$

Here, given that the equivalent scattering coefficient is μs′(r), in a general, three-dimensional model, there is the relationship expressed by D(r)=3·μs′(r))⁻¹ between the equivalent scattering coefficient μs′(r) and the diffusion coefficient D(r). μs′(r) is the equivalent scattering coefficient, and, in the present exemplary embodiment, is a value used in reconstructing a two-dimensional tomographic image along the measurement plane 92. In the case of a two-dimensional model, there is the relationship expressed by D(r)=(2·μs′(r))⁻¹ between the diffusion coefficient D(r) and the equivalent scattering coefficient μs′.

The equivalent scattering coefficient μs′ indicates the scattering coefficient in an isotropic scattering region in a substance (an anisotropic scattering medium) that includes an anisotropic scattering region and an isotropic scattering region. In the light diffusion equation, only the isotropic scattering region is the object, and here, the equivalent scattering coefficient μs′ is used.

In a case in which continuous light is used for optical tomographic measurement, the distribution of the light intensity is uniform regardless of time, and therefore, the light diffusion equation of formula (1) can be expressed by formula (2).

{∇·D(r)∇−μₐ(r)}Φ(r)=⁻q(r) (2)

When the diffusion coefficient D(r) and the absorption coefficient μa(r) that are optical characteristic values are already known, computation as a forward problem can be carried out in a case in which the intensity distribution of the light that exits from the mouse 12 (the subject holder 30) is determined by using the light diffusion equation expressed by formula (2). However, the light intensity distribution is already known. From this, in a case in which an optical characteristic value of the mouse 12 is determined by using the light diffusion equation, there becomes inverse problem computation.

Here, the diffusion coefficient D(r) and the absorption coefficient μa(r) of the mouse 18 differ in accordance with the wavelength of the light. Given that the diffusion coefficient with respect to wavelength λs of the excitation light is Ds(r), the absorption coefficient is μas(r), and the light density of the light source is qs(r), the diffusion equation with respect to the excitation light is expressed by formula (3). Further, given that the diffusion coefficient with respect to wavelength λf of the fluorescence is Dm(r), the absorption coefficient is μam(r), and the light density whose light source is the fluorescence is qm(r), the light diffusion equation with respect to the fluorescence is expressed by formula (4).

{∇·Dₛ(r)∇−μₐₛ(r)}Φₛ(r)=−qₛ(r) (3)

{∇·Dₘ(r)∇−μₐₘ(r)}Φₘ(r)=−qₘ(r) (4)

Further, the light density qm(r) of the fluorescence can be expressed by qm(r)=γ·εN(r)·Φ(r), by using the light density Φs(r) within the mouse 12, the quantum efficiency γ of the fluorescent labeling agent, and the molar absorption coefficient ε. Accordingly, formula (4) is replaced by formula (5).

{∇·Dₘ(r)∇−μₐₘ(r)}Φₘ(r)=−γεN(r)Φₛ(r) (5)

Here, if the absorption coefficient μa(r) and the equivalent scattering coefficient μs′(r) (diffusion coefficient D(r)) that are optical characteristics of the mouse 12 are already known, in formula (3) and formula (5), substitutions of Ds(r)=Dm(r)=D(r) and μas(r)=μa(r)+ε·N(r) and μam(r)=μa(r) can be carried out. From this, formula (3) and formula (5) are replaced by formula (6) and formula (7). Note that ε·(r) expresses the absorption by the fluorescent labeling agent.

{∇·D(r)∇−μₐ(r)−ΕN(r)}Φₛ(r)=−qₛ(r) (6)

{∇·D(r)∇−μₐ(r)}Φₘ(r)=−γεN(r)Φₛ(r) (7)

The intensity of the fluorescence whose light source is the fluorescent labeling agent is based on the intensity Φs(r) of the excitation light. The intensity qs(r) of the light source of the excitation light is already known. Due to the equivalent scattering coefficient μs′(r) (diffusion coefficient D(r)) and the absorption coefficient μa(r) being already known, the light intensity Φs(r) within the mouse 12 can be determined as a forward problem by a numerical analysis method such as the finite element method or the like.

On the basis thereof, at the data processing device 16, forward problem computation, and reverse problem computation of one system, are carried out by using the measurement data M(x, θ, m), and the density distribution N(r) of the fluorescence emitted from the fluorescent labeling agent of the mouse 12 at the interior of the subject holder 30 is obtained.

On the other hand, as shown in FIG. 5, at the optical measuring device 14, a stepping motor 56A for example is provided as the driving source of the slider 56. At the slider 56, an unillustrated feed screw is rotated by the stepping motor 56A, and the slide base 58 is moved (see FIG. 3). The controller 62 controls the driving of the stepping motor 56A via the driving circuit 66.

Due thereto, at the optical measuring device 14, the relative position of the subject holder 30 with respect to the measurement plane 92 of the measuring head section 22 is grasped on the basis of the driving of the stepping motor 56A.

As shown in FIG. 2, at the subject holder 30 that is applied to the present exemplary embodiment, the mouse 12 is held by the recess 32A formed in the upper mold block 32 and the recess 34A formed in the lower mold block 34. At this time, at the subject holder 30, the position of the mouse 12 within the subject holder 30 is prescribed by the positions of the recesses 32A, 34A with respect to the reference surface 38.

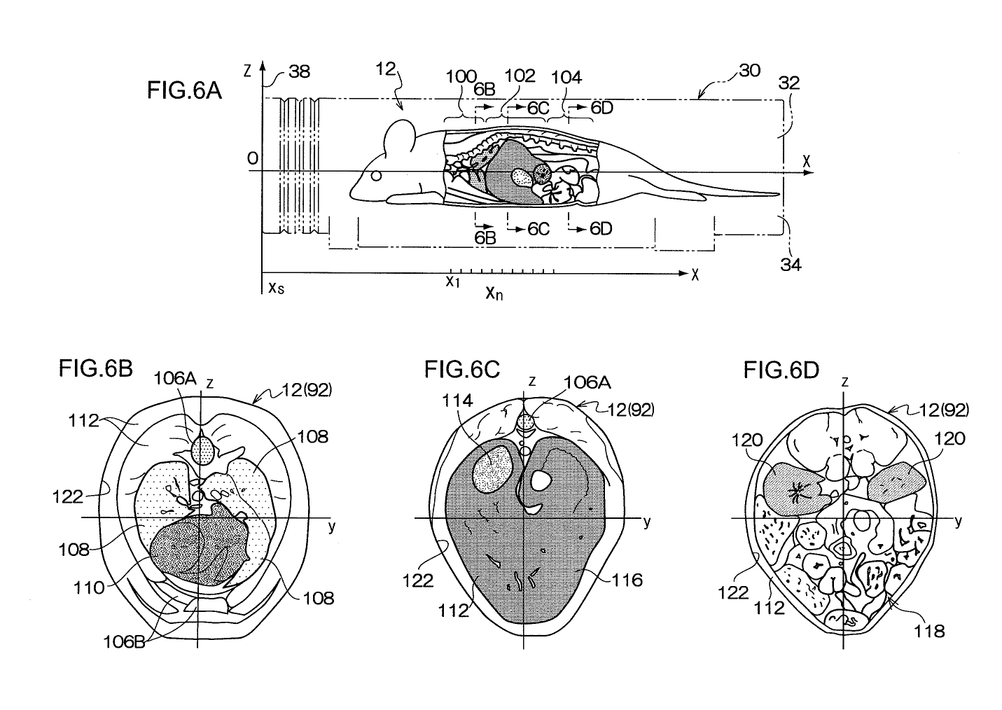

Further, as shown in FIG. 6A, because the anatomic structure of the internal structures (the innards) of the mouse 12 is complete, when the mouse 12 is held in the subject holder 30, the internal structures that are positioned at the predetermined measurement plane 92 can be thought to be substantially the same due to the physique of the mouse 12. At this time, measurement positions x₁ through x₁₅ of the optical measuring device 14 relating to the present exemplary embodiment are positioned at a chest portion 100, an abdominal portion 102, and a hip portion 104 of the mouse 12. Note that, hereinafter, in addition to internal organs such as the lungs, heart, stomach, liver, intestines, kidneys and the like, bone tissue, and soft tissue such as muscles, fat and the like, are collectively called internal structures.

FIG. 6B is a cross-sectional view at a position included in the chest portion 100 of the mouse 12 shown in FIG. 6A. As shown in FIG. 6B, in the chest portion 100 of the mouse 12, lungs 108 and a heart 110 are positioned around a bone 106A, and bones 106B, muscles 112, and fat 122 are positioned so as to cover these.

FIG. 6C is a cross-sectional view at a position included in the abdominal portion 102 of the mouse 12 shown in FIG. 6A. As shown in FIG. 6C, in the abdominal portion 102 of the mouse 12, there is the bone 106A, and the majority of the space is occupied by the stomach 114 and the liver 116, and the muscles 112 and the fat 122 are positioned so as to cover these.

FIG. 6D is a cross-sectional view at a position included in the hip portion 104 of the mouse 12 shown in FIG. 6A. As shown in FIG. 6D, the bone 106A, and internal organs such as intestines 118 and kidneys 120 and the like, and the muscles 112 and the fat 122 that cover these, are positioned at the hip portion 104 of the mouse 12.

Namely, at the optical measuring device 14 relating to the present exemplary embodiment, on the basis of the moved distance (measurement position xn) of the measurement plane 92 with respect to the reference surface 38, the position of the measurement plane 92 in the body length direction of the mouse 12 is grasped, and the distribution of the internal structures of the mouse 12 in the measurement plane 92 can be specified.

Here, as shown in Table 1, at a living body such as the mouse 12 or the like, the optical characteristics such as the absorption coefficient μa, the equivalent scattering coefficient and the like differ in accordance with the internal structures.

TABLE 1
Optical Characteristic Values of Mouse Internal Structures

| | | |
|---|---|---|
| | equivalent | |
| | scattering | absorption |
| | coefficient μs′ | coefficient |
| internal structures of mouse | (1/cm) | μa (1/cm) |

chest portion 100 (internal organs)

| | | |
|---|---|---|
| lungs 108 | 20.77 | 0.79 |
| heart 110 | 8.53 | 0.25 |

abdominal portion 102 (internal organs)

| | | |
|---|---|---|
| stomach 114 | 13.22 | 0.06 |
| liver 116 | 6.20 | 1.45 |

hip portion 104 (internal organs)

| | | |
|---|---|---|
| Intestines 118 | 10.33 | 0.05 |
| kidneys 120 | 19.79 | 0.28 |

bone tissue

| | | |
|---|---|---|
| bones 106A/B | 22.00 | 0.25 |

soft tissue

| | | |
|---|---|---|
| muscles 112 | 3.37 | 0.36 |
| fat 112 | 11.54 | 0.02 |

Thus, the data processing device 16 relating to the present exemplary embodiment specifies the internal structures in the measurement plane 92 on the basis of the measurement position xn, and prepares an optical characteristic distribution from the position of the internal structures and the optical characteristic values (the absorption coefficient μa, the equivalent scattering coefficient μs′) that differ per internal structure, and stores the prepared optical characteristic distribution in the ROM 80 or the HDD 84 or the like of the data processing device 16.

More concretely, in the present exemplary embodiment, as shown in FIG. 6A, explanation is given with the center at the reference surface 38 of the subject holder 30 being origin O, the moving direction of the subject holder 30 that passes through the origin O being the x-axis, and the axes on the reference surface 38 that pass through the origin O and are respectively perpendicular to the x-axis being the y-axis and the z-axis. At this time, as shown in FIG. 6B through FIG. 6D, the measurement plane 92 that is each cross-section of the mouse 12 is on the z-axis and the y-axis. Due thereto, the cross-section of the mouse 12 can be expressed by two-dimensional coordinates with each of the measurement planes 92 being a yz coordinate.

Namely, the distribution of the internal structures within each cross-section is two-dimensional coordinates on the y-axis and the x-axis with respect to the origin O in the measurement plane 92, and the optical characteristic values (the absorption coefficient μa, the equivalent scattering coefficient μs′) of the main internal structures are stored in advance at the coordinate positions. Note that, although the lungs, heart, stomach, liver, intestines, kidneys, bone tissue, muscles, fat and the like are used as the main internal structures (see Table 1), the present invention is not limited to the same and other internal structures can be used.

In this way, in the optical tomographic measuring system 10, on the basis of the distribution of the internal structures corresponding to the measurement position xn of the mouse 12, the absorption coefficient μa(r) and the equivalent scattering coefficient μs′(r) that are used as the optical characteristic values are set, and an optical characteristic distribution corresponding to the distribution of the internal structures is stored in the ROM 80 or the HDD 84 of the data processing device 16. At the data processing device 16, the absorption coefficient μa and the equivalent scattering coefficient μs′ are set to the absorption coefficient μa(r) and the equivalent scattering coefficient μs′(r), and reconstruction of an optical tomographic image that is based on the measurement data M(xn, θp, m) is carried out.

Note that, although it is actually three-dimensional, the optical characteristic values are set in two dimensions in this way, and can be used in computation.

The reconstructing of an optical tomographic image at the optical tomographic measuring system 10 relating to the present exemplary embodiment is described hereinafter.

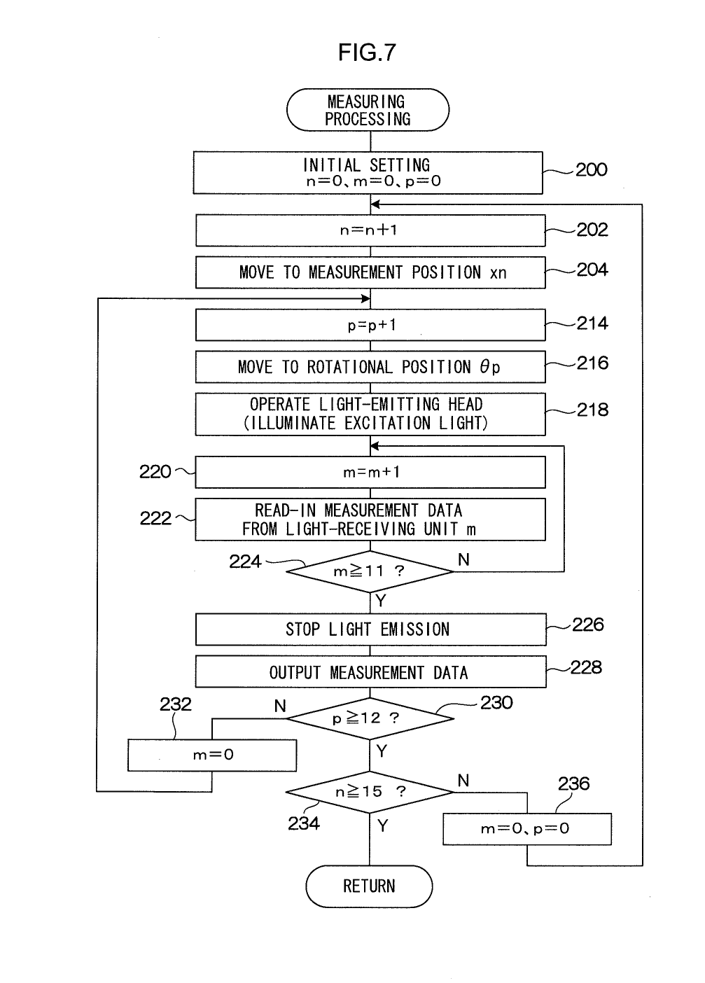

A summary of the measuring processings at the optical measuring device 14 provided at the optical tomographic measuring system 10 is shown in FIG. 7. This flowchart is implemented when the subject holder 30 that accommodates the mouse 12 is installed in the optical measuring device 14 and the start of measuring processing is instructed. Note that, here, the measurement position x is measurement position xn, and measurement is carried out at an interval of Δx (e.g., Δx=3 mm) from n=1 through 15. At each of the measurement positions xn, the measuring head portion 22 is rotated in order at 30° intervals from p=1 through 12, with the rotational position θ of the light source unit 40 being rotational position θp, and measurement of the fluorescence is carried out at each of the light-receiving units 42 of m=1 through 11. Operation of the optical measuring device 14 is controlled by the data processing device 16.

In initial step 200, initial setting is carried out, and values are set to m=0, n=0, and p=0. In step 202, n is incremented (n=n+1). Next, in step 204, by driving the stepping motor 56A and operating the slider 56, the initial position (measurement position x₁) of the measurement positions xn of the mouse 12 is moved so as to correspond to the measuring head portion 22.

When the mouse 12 moves to the measurement position xn at which measurement of fluorescence is carried out, in step 214, p is incremented (p=p+1). In step 216, by operating the rotating actuator 28, the measuring head portion 22 is rotated, and the light source unit 40 moves to the original position θ₁.

Thereafter, in step 218, the light-emitting head 68 of the light source unit 40 is operated and illuminates excitation light toward the subject holder 30. Together therewith, in step 220, m is incremented (m=m+1). In step 222, the light amount of the fluorescence received at the light-receiving unit 42 corresponding to m is read-in as measurement data D(m) of measurement position xn and rotational position θp. Further, in step 224, it is confirmed whether or not measurement data has been read-in from all of the light-receiving units 42 (m≧11). If m is not greater than or equal to 11, the judgment in step 224 is negative, the routine moves on to step 220, and the next measurement data M(m) is read-in.

When the measurement data of all of the light-receiving units 42 at the measurement position xn and the measurement angle θp have been read-in, the judgment in step 224 is affirmative. The routine moves on to step 226 where emission of light by the light source unit 40 is stopped, and the read-in measurement data M(xn, θp, m) is outputted to the data processing device 16 (step 228).

In next step 230, is it confirmed whether or not the light source unit 40 has moved an entire one circumference (p≧12) at the measurement position xn. If the judgment is negative, m is reset (m=0) (step 232), and the routine moves on to step 214.

In this way, at measurement position xn, the light source unit 40 is rotated from measurement positions θ₁ through θ₁₂, and when measurement of the measurement data M(xn, θp, m) is finished, the judgment in step 230 is affirmative, and the routine moves on to step 234. In step 234, it is confirmed whether or not measurement at all of the measurement positions xn is finished (n≧15). If the judgment is negative, in step 236, m and p are set to m=0 and p=0, and the routine moves on to step 202, and measurement at the next measurement position xn is started. Further, when measurement at all of the measurement positions xn (x₁ through x₁₅) is finished, the judgment in step 234 is affirmative, and the measuring processing ends. Note that, when the measuring processing ends, the slider 56 is operated, and the subject holder 30 is returned to the installation/removal position.

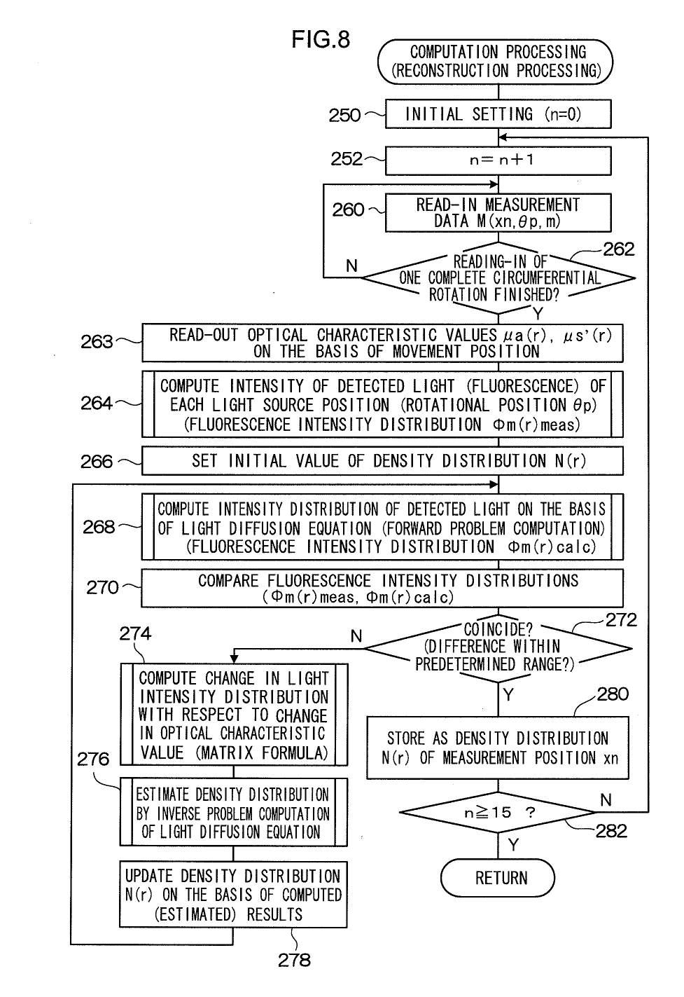

On the other hand, a summary of the processings at the data processing device 16 that are based on the measurement data M(xn, θp, m) of the optical measuring device 14 is shown in FIG. 8. This flowchart is executed by the measuring processing at the optical measuring device 14 being started.

In this flowchart, in step 250 and step 252, first, setting of the measurement position xn is carried out. Note that, here, after n is initialized (n=0), n is incremented (n=n+1), and is thereby set to the initial measurement position xn (measurement position x₁).

In next step 260, the measurement data outputted from the optical measuring device 14 is read-in in order. In step 262, it is confirmed whether or not reading-in of the measurement data M(xn, θp, m) of the entire one circumferential rotation of the light source unit 40 (data from p=1 through 12) at the measurement position xn is finished.

Here, when the measurement data M(xn, θp, m) of the entire one circumferential rotation is read-in, the judgment in step 262 is affirmative, and the routine moves on to step 263. In step 263, the absorption coefficient μa(r) and the equivalent scattering coefficient μs′(r), that are optical characteristic values of the mouse 12, at the measurement position xn are read-out and set.

In the present exemplary embodiment, the position of the measurement plane 92 in the body length direction of the mouse 12 is specified from the relative position of the subject holder 30 with respect to the measurement plane 92 by the driving of the stepping motor 56A. The optical characteristic distribution of the mouse 12 at this position is grasped by a two-dimensional coordinate. Thus, the absorption coefficients μa(r) and the equivalent scattering coefficients μs′(r) that are set in advance for all of the two-dimensional coordinates of the y-axis and z-axis relating to the measurement plane 92, i.e., for each of the coordinate positions (r) with respect to the origin O, are read-in.

In nest step 264, fluorescence intensity distribution (fluorescence intensity distribution Φm(r)meas) is computed from the read-in measurement data M(xn, θp, m). Namely, the fluorescence intensity distribution Φm(r)meas that is based on the measurement data M(xn, θp, m) is acquired.

Thereafter, in step 266, the initial value of density distribution N(r) of the fluorescence (fluorescent labeling agent) within the subject holder 30 that contains the mouse 12 is set. In step 268, fluorescence intensity distribution Φm(r)calc that exits from the mouse 12 is computed on the basis of the set density distribution N(r) and the absorption coefficients μa(r) and the equivalent scattering coefficients μs′(r) (diffusion coefficients D(r)) that were set previously. Namely, the virtual fluorescence intensity distribution Φm(r)calc is acquired. This fluorescence intensity distribution Φm(r)calc can be easily computed by making a light diffusion equation, that is a mathematical model, be a known forward problem computation that uses a numerical analysis method such as the finite element method or the like.

Namely, excitation light intensity distribution Φs(r)calc is obtained from formula (6) and formula (8). Light intensity distribution Φt(r)calc, that combines excitation light and fluorescence, is obtained from formula (9). The fluorescence intensity distribution Φm(r)calc is obtained from the excitation light intensity distribution Φs(r)calc and the light intensity distribution Φt(r)calc (refer to formula (10)).

{∇·D(r)∇−μₐ(r)−εN(r)}Φₛ(r)=−qₛ(r) (6)

{∇·D(r)∇−μₐ(r)−εN(r)}Φₛ(r)=−qₛ(r) (8)

{∇·D(r)∇−μₐ(r)}Φₜ(r)=−qₛ(r) (9)

Φₘ(r)=γ(Φₜ(r)−Φₛ(r)) (10)

In next step 270, the fluorescence intensity distribution Φm(r)meas, that is based on the measurement data, and the fluorescence intensity distribution Φm(r)calc, that is based on the results of computation, are compared, and in step 272, it is confirmed whether or not these distributions coincide. This judgment may be carried out by, for example, using the square error y of the fluorescence intensity distribution Φm(r)meas and the fluorescence intensity distribution Φm(r)calc, and judging whether or not the square error y is within a prescribed value that is set in advance.

Here, if the square error y is greater than the prescribed value and it is judged that the fluorescence intensity distribution Φm(r)meas and the fluorescence intensity distribution Φm(r)calc do not coincide, the judgment in step 272 is negative, and the routine moves on to step 274.

In step 274, the change in the light intensity distribution with respect to the change in the optical characteristic value is computed by a known method using a Jacobian matrix. In next step 276, the error (e.g., the square error y) of the fluorescence intensity distribution Φm(r)meas and the fluorescence intensity distribution Φm(r)calc is evaluated by using inverse problem computation in accordance with an optimization method such as the Levenberg-Marquardt method or the like. Namely, the square error y is obtained from formula (11), and this square error y is evaluated. Note that γ is the quantum efficiency and ε is the molar absorption coefficient.

y=∥Φₘ(r)ₘₑₐₛᵤᵣₑ−Φₘ(r)_{calc}∥² (11)

Further, in this step 276, absorption εN of the fluorescence at the fluorescent labeling agent that makes this square error y be a minimum, i.e., the density distribution N(r) of the fluorescent labeling agent, is estimated. This can be estimated by carrying out inverse problem computation using formula (7) or formula (12) that are light diffusion equations.

{∇·D(r)∇−μₐ(r)}Φₘ(r)=−γεN(r)Φₛ(r) (7)

{∇·D(r)∇−μₐ(r)}Φₘ(r)=−γεN(r)Φₛ(r) (12)

When the density distribution N(r) is determined in this way, in step 278, the density distribution N(r) is updated on the basis of these computational results.

The data processing device 16 repeats step 268 through step 278 until it is considered that the fluorescence intensity distribution Φm(r)meas and the fluorescence intensity distribution Φm(r)calc coincide.

Due thereto, when it is considered that the fluorescence intensity distribution Φm(r)meas and the fluorescence intensity distribution Φm(r)calc coincide, the judgment in step 272 is affirmative. The routine moves on to step 280 where the density distribution N(r) at this time is stored as the density distribution N(r) obtained from the measurement data M(xn, θp, m). A tomographic image of the fluorescence distribution at the measurement position xn is obtained by using this density distribution N(r).

When the computation with respect to the measurement position xn ends in this way, in step 282, it is confirmed whether or not processing with respect to all of the measurement positions xn is finished (n≧15). If the judgment is negative, the routine moves on to step 252, and processing with respect to the next measurement position xn is carried out.

In this way, at the data processing device 16, by setting in advance the absorption coefficient μa(r) and the equivalent scattering coefficient μs′(r) that are optical characteristics of the mouse 16, the density distribution (r) of the fluorescence can be obtained if there is measurement data of the fluorescence intensity. Therefore, measurement can be simplified and the measuring time can be shortened. Further, at the data processing device 16, because it suffices for inverse problem computation of a light diffusion equation to be carried out with respect to the fluorescence, the processing load is reduced.

At the optical tomographic measuring system 10, the absorption coefficient μa(r) and the equivalent scattering coefficient μs′(r) can be set appropriately for each coordinate (r) within the measurement plane 92. Therefore, a highly-accurate density distribution N(r) of the fluorescence can be obtained as compared with a case in which the entire body of the mouse 12 is set to the same the absorption coefficient μa(r) and equivalent scattering coefficient μs′(r).

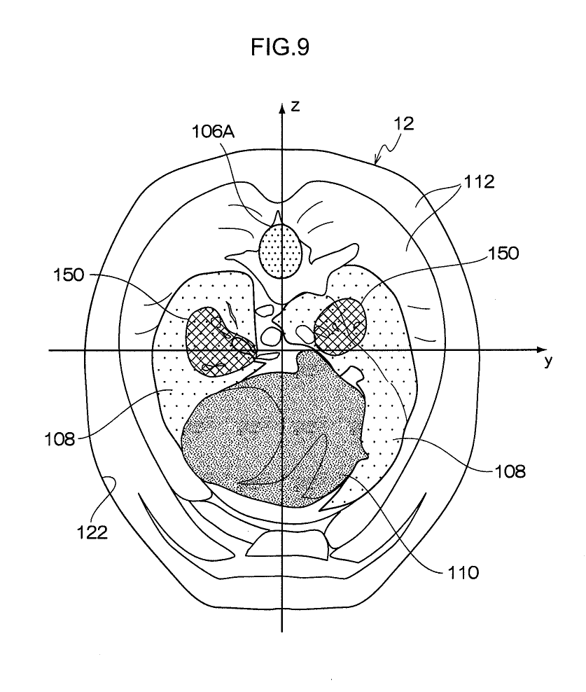

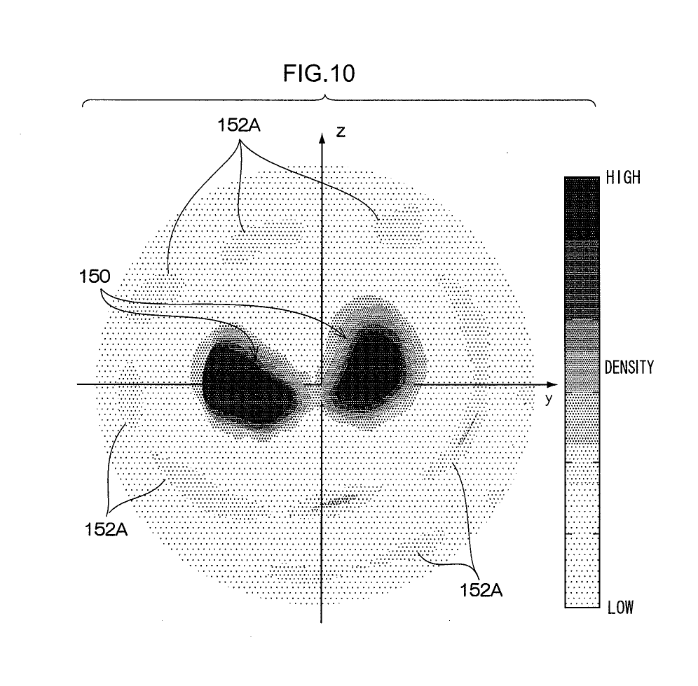

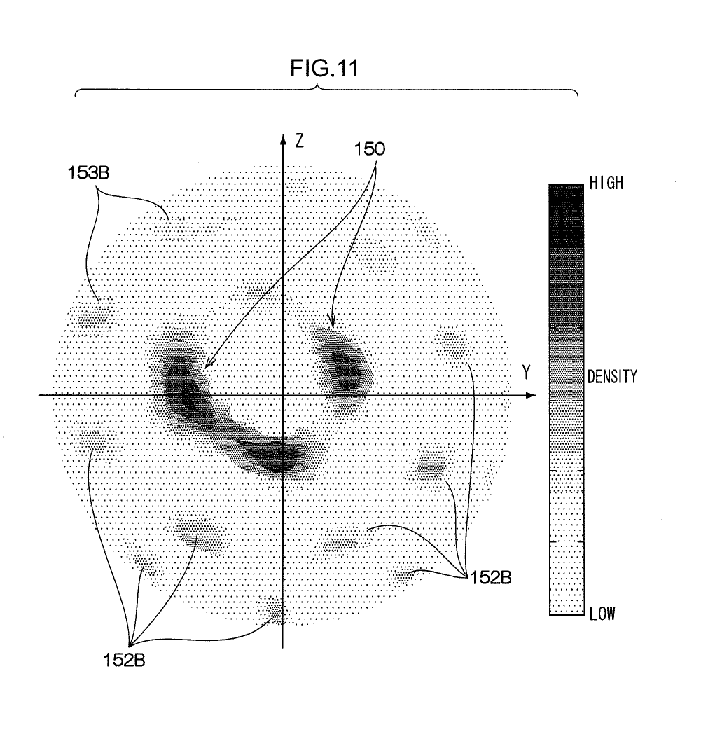

For example, a cross-section of the chest portion 100 of the mouse 12 is shown in FIG. 9. The bone 106A, the heart 110, the muscles 112 that cover these, as well as the lungs 108 to which the fluorescent labeling agent has adhered, exist in the measurement plane 92 of the mouse 12. Results, that are obtained by using the optical tomographic measuring system 10 relating to the present exemplary embodiment at the time of carrying out reconstruction of the density distribution of the fluorescence of this measurement plane 92, are shown in FIG. 10, and results that are obtained by not using the optical tomographic measuring system 10 are shown in FIG. 11.

At this time, in FIG. 11, the average value of the entire body of the mouse 12 is set as the optical characteristic value. Therefore, in the reconstructed image, the shape of a fluorescent labeling agent 150 breaks-down as compared with the fluorescent labeling agent 150 in FIG. 9. Further, the number of noises (artifacts) 152B that do not originally exist is large, and the fluorescence density also is high. Therefore, it is also difficult to judge whether or not a high density region is noise.

On the other hand, in FIG. 10, because the optical characteristic value is set three-dimensionally, the two fluorescent labeling agents 150 on the measurement plane 92 are expressed accurately (the fluorescence density is high). Further, even though noises 152A are displayed, because the density thereof is low, it is clearly understood that such regions are noise.

Note that the above-described present exemplary embodiment illustrates an example of the present invention, and does not limit the structure of the present invention. The present invention is not limited to the optical tomographic measuring system 10, and can be applied to an optical tomographic measuring device of an arbitrary structure that illuminates excitation light onto a living body that is an object of measurement, and measures the fluorescence, that exits from the object of measurement due to the excitation light, at plural positions at the periphery of the object of measurement.

Further, in the present exemplary embodiment, a distribution of internal structures of the mouse 12 that has an average physique is supposed, and the optical characteristic value distribution of each cross-section is set. However, the present invention is not limited to the same. The distribution of the internal structures of each physique of the mouse 12 may be supposed, and the optical characteristic value distribution of each cross-section may be set in plural patterns. In this case, at the data processing device 16, it suffices for the user to select the optical characteristic value distribution pattern that corresponds to the physique of the mouse 12 that is the object of measurement.

What is claimed is:

1. An optical tomographic measuring device comprising:
an illuminating component whose optical axis is disposed so as to be in a measurement plane that intersects a body length direction of a living body that is an object of measurement and to which a fluorescent labeling agent is administered, the illuminating component illuminating excitation light toward the object of measurement;
a plurality of light-receiving components whose respective optical axes are disposed so as to be in the measurement plane, the light-receiving components receiving fluorescence, that is emitted from the fluorescent labeling agent due to the excitation light illuminated from the illuminating component and that exits at a periphery of the object of measurement;
a storage component that stores an optical characteristic distribution of the object of measurement;
a specifying component that specifies a position of the measurement plane in the body length direction;
an acquiring component that acquires, from the storage component, an optical characteristic distribution that corresponds to the position specified by the specifying component; and
a constructing component that constructs a density distribution of fluorescence in the measurement plane, on the basis of intensities of the fluorescence received at the respective light-receiving components and the optical characteristic distribution acquired by the acquiring component.

2. The optical tomographic measuring device of claim 1, further comprising a moving component that moves the measurement plane by moving the illuminating component and the light-receiving components as a set, relative to the object of measurement along the body length direction,
wherein the specifying component specifies the position of the measurement plane on the basis of a movement amount of the moving component.

3. The optical tomographic measuring device of claim 1, wherein the optical characteristic distribution is set in advance in accordance with at least one of lungs, a heart, a stomach, a liver, intestines, kidneys, bones, muscles and fat that structure the living body.

4. The optical tomographic measuring device of claim 1, wherein the optical characteristic distribution is structured by an absorption coefficient and an equivalent scattering coefficient of light.
